(19) United States
(12) Patent Application Publication
(10) Pub. No.: US 2020/0182321 A1
(43) Pub. Date: Jun. 11, 2020

(54) FRICTION MATERIAL FOR DRY BRAKES

(71) Applicant: ADVICS CO., LTD., Kariya-shi (JP)

(72) Inventors: Junichi UJITA, Miyoshi-shi (JP); Manami SUGIRA, Takahama-shi (JP); Katsuya OKYAMA, Ngakute-shi (JP); Takatoshi TAKEMOTO, Nagoya-shi (JP); Kenji ABE, Toyota-shi (JP); Toru MATSUSHIMA, Toyota-shi (JP); Mamoru TOYAMA, Nagakute-shi (JP); Yuji NAGASAWA, Nagakute-shi (JP); Nnvoru SUGIURA, Nagakute-shi (JP)

(73) Assignee: ADVICS CO., LTD., Kariya-shi (JP)

(21) Appl. No.: 16/633,478

(22) PCT Filed: Jul. 23, 2018
(86) PCT No.: PCT/JP2018/027509

§ 371 Date: Jan. 23, 2020

(30) Foreign Application Priority Data
Jul. 24, 2017 (JP) 2017-142953

(51) Int. Cl. F16D 69/02

(52) U.S. Cl. CPC F16D 69/026; F16D 2200/0073; F16D 2200/0065

(57) ABSTRACT

A friction material for dry brakes containing, as raw friction materials, a fiber substrate, a binder, an organic filler, and an inorganic filler, wherein porous silica including a plurality of pores with a central pore diameter of 1.0 nm or greater and 50.0 nm or smaller that absorbs liquid matter generated by thermal decomposition of an organic matter in the friction material at the time of brake braking is contained as the inorganic filler.

### TECHNICAL FIELD

The present invention relates to a friction material for dry brake used for a brake device or the like for vehicles.

### BACKGROUND ART

The friction material for dry brake used for brake pads, brake shoes of vehicles and the like is required to have various characteristics such as high effect (high friction coefficient), long lifespan (wear resistance), prevention of generation of noise, and the like. In the friction material for dry brakes, the decrease in the friction coefficient at the time of high-speed high-load braking, the so-called fade phenomenon, is said to be caused by the fact that the liquid matter obtained by thermally decomposing organic matter under a high-temperature environment such as during high-speed high-load braking exists on the friction surface as a fluidized layer. Therefore, in the friction material composition, it is considered possible to suppress the occurrence of the fade phenomenon by reducing the content of organic matters such as organic fillers and binders.

However, decrease in amount of the organic matter induces problems such as, (i) a decrease in the resin used in the binder, and the like leads to a decrease in the strength of the friction material, and (ii) a decrease in the organic filler leads to decrease in the flexibility and wear resistance of the friction material, and thus it is not realistic.

For example, cashew dust, which is widely used as an organic filler, has problems with heat resistance, such as thermal decomposition and liquefaction under a high temperature environment, and thus a technique of compounding vulcanized rubber with a friction material instead of cashew dust to suppress fluctuations in brake effectiveness at the time of high-speed braking has been reported (see Patent Literature 1). The vulcanized rubber to be compounded vulcanizes natural rubber, styrene rubber, butadiene or the like to improve heat resistance.

Furthermore, a technique of compounding, instead of cashew dust, melamine cyanurate, which has sublimation properties and is easily gasified, to the friction material to prevent the occurrence of fade phenomenon at the time of braking by liquid matter and increase the friction coefficient has been reported (see Patent Literature 2).

Moreover, a technique of compounding leaf-like silica to the friction material to absorb gas-liquid matter due to thermal decomposition of the organic matter and suppress the occurrence of fade phenomenon in which the friction coefficient of the friction surface greatly decreases has been reported (see Patent Literature 3). In the technique of Patent Literature 3, the gas-liquid matter generated when the organic matter of the binder such as phenolic resin is thermally decomposed is absorbed into the pores of the leaf-like silica, so that the gas-liquid matter can be prevented from remaining on the friction surface and the occurrence of fade phenomenon in which the friction coefficient of the friction surface decreases can be suppressed.

### CITATIONS LIST

### Patent Literatures

Patent Literature 1: Japanese Unexamined Patent Application Publication No. 2007-254564

Patent Literature 2: Japanese Unexamined Patent Application Publication No. 10-330731

Patent Literature 3: Japanese Unexamined Patent Application Publication No. 2009-102584

### SUMMARY OF INVENTION

### Technical Problems

In the friction material for dry brakes, a friction surface between the rotor and the pad when a high-temperature fade occurs is 400° C. or higher, and a high frictional force is applied. For this reason, it is necessary for the friction material for dry brakes to eliminate the liquid matter due to thermal decomposition of organic matter generated during high-speed, high-load braking, and the like from the friction surface in order to suppress the decrease in the friction coefficient at the time of fading, and it is required to have a high absorption efficiency for the thermally decomposed liquid matter of the organic matter. In this regard, in the wet friction material in which a certain amount of lubricating oil always exists on the friction surface, the temperature of the friction surface does not become high, and if the oil is absorbed all at once, the holding power of the oil is impaired, and conversely the cooling property and heat resistance property reduce, which is a problem unique to the friction material for dry brakes.

In the technique of Patent Literature 1, since the vulcanized rubber is thermally decomposed to form a liquid matter, the fading performance still has room for improvement. Furthermore, since the melamine cyanurate described in Patent Literature 2 forms a layered crystal structure and has lubricating performance, it is expected that the effect of improving the friction coefficient is limited. Moreover, since melamine cyanurate is not a flexible material such as cashew dust, it cannot absorb brake vibration, and there is a high possibility that brake characteristics such as brake squeal will deteriorate.

As the shape of the leaf-like silica described in Patent Literature 3 is considered to be close to flaky silica, leaf-like mineral, and the like, the size of the pores of the leaf-like silica is estimated to be several μm or more. The large pores have a high possibility of being partially blocked and disappearing due to the inflow of a binder such as phenolic resin at the time of high temperature/high pressure molding of the friction material, the clogging by wear powder generated during braking, or the like. Therefore, there is a possibility that a sufficient absorption effect of the gas-liquid matter cannot be exhibited and the occurrence of the fade phenomenon cannot be effectively suppressed.

It is an object of the present invention to provide a friction material for dry brakes which has sufficient strength, and has excellent fading performance while maintaining excellent flexibility and wear resistance.

### Solutions to Problems

The inventors of the present invention have conducted an intensive research to solve the above problems, and found that decrease in the friction coefficient at the time of high-speed high-load braking and the like is suppressed and excellent fading performance is exhibited by containing porous silica including a large number of pores having a specific central pore diameter in the friction material. Furthermore, the inventors have found that it has sufficient strength and excellent flexibility and wear resistance are maintained, and came to complete the present invention.

In other words, the present invention has the following characteristic configurations.

A friction material for dry brakes containing, as raw friction materials, a fiber substrate, a binder, an organic filler, and an inorganic filler, where porous silica including a plurality of pores with a central pore diameter of 1.0 nm or greater and 50.0 nm or smaller is contained as the inorganic filler.

According to the configuration described above, the friction material for dry brakes excelling in the fading performance which suppresses the decrease in the friction coefficient at the time of high-speed high-load braking and the like can be provided. An excellent effect of suppressing the decrease in the friction coefficient at the time of high-speed high-load braking can be exhibited as the porous silica absorbs the liquid matter of the organic matter thermally decomposed under a high-temperature environment that causes the fade phenomenon. In particular, by having the central pore diameter of the porous silica at 50.0 nm or smaller, inconveniences such as liquid matter flowing into the pores and clogging the pores during molding of the friction material can be prevented, and a large number of pores are formed with respect to the molded friction material. The desired absorption performance is exhibited with respect to the molecular size caused by the thermal decomposition of the organic matter by having the central pore diameter of the porous silica at 1.0 nm or greater. Thus, since the effect of suppressing decrease in the friction coefficient at the time of excellent high-speed high-load braking without limiting the compounding amount of the organic matter such as the organic filler, the binder, and the like can be exhibited, it has sufficient strength and can maintain excellent flexibility and wear resistance.

### BRIEF DESCRIPTION OF DRAWINGS

FIG. 1 is a view summarizing a compounding composition of raw friction materials and the performance evaluation thereof according to examples and comparative examples of the friction material for dry brakes in accordance with the present embodiment.

### DESCRIPTION OF EMBODIMENTS

Hereinafter, although an embodiment of the present invention is described in detail, the present invention is not limited by the following embodiment to an extent not exceeding its purpose.

The friction material for dry brakes according to the present embodiment is a non-asbestos-based friction material (NAO material). Furthermore, unlike a wet type friction material in which the friction surface is lubricated with lubricating oil, it is a friction material for dry brakes in which the friction surface is not lubricated.

The friction material for dry brakes according to the present embodiment includes a fiber substrate, a binder, an organic filler, an inorganic filler, and the like, which will be described later, and, as an inorganic filler, contains porous silica including a large number of pores having a specific central pore diameter. In addition to these, materials generally used in producing the friction material for dry brakes can also be contained. Here, all the materials mixed in producing the friction material for dry brakes according to the present embodiment are referred to as raw friction materials.

The fiber substrate can be exemplified by organic fibers, metal fibers, natural or synthetic inorganic fibers, and the like. Specific examples of the fiber substrate include, as organic fibers, aromatic polyamide fibers (aramid fibers), acrylic fibers, cellulose fibers, carbon fibers, and the like. Examples of metal fiber include pure metals such as steel, stainless steel, aluminum, zinc, and tin, and fibers made of respective alloy metals. Examples of inorganic fiber include rock wool, glass fiber and the like. The fiber substrate may be used alone or in combination of two or more types. Furthermore, the contained amount of the fiber substrate is not particularly limited, but it can be contained preferably in an amount of 3.0 to 15.0 wt % with respect to the total amount of raw friction materials.

The binder has a function of binding the raw friction materials. Specific examples of the binder include phenolic resin, epoxy resin, melamine resin, and imide resin, and modified resins thereof such as elastomer, hydrocarbon resin, and epoxy can also be used. A binder can also be used alone or in combination of two or more types. Furthermore, the contained amount of the binder is not particularly limited, but it can be contained preferably in an amount of 3.0 to 15.0 wt %, particularly preferably 3.0 to 10.0 wt % with respect to the total amount of raw friction materials.

The organic filler can contain cashew dust, rubber powder, tire powder, fluoropolymer and the like, which can be used alone or in combination of two or more types. However, the present invention is not limited to the specific examples described above, and organic fillers known in the technical field can be preferably used. The contained amount of the organic filler is not particularly limited. However, when there are too few organic fillers, the flexibility and wear resistance of a friction material reduce, and when there are too many organic fillers, the moldability reduces. Since the organic filler becomes a liquid matter due to thermal decomposition and becomes the cause of fade phenomenon, the contained amount is preferably determined according to the pore volume and the like of the porous silica. For example, it can be contained in an amount of preferably 1.0 to 10.0 wt %, particularly preferably 3.0 to 8.0 wt % with respect to the raw friction materials.

As the inorganic filler, porous silica having a large number of pores having a specific central pore diameter is contained. The porous silica is a substance mainly composed of a silicon oxide such as silicon dioxide having a porous structure in which many fine pores are formed.

The central pore diameter of each pore of the porous silica is in the range of 1.0 nm or greater and 50.0 nm or smaller, preferably in the range of 2.0 nm or greater and 20.0 nm or smaller, particularly preferably in the range of 2.0 nm or greater and 7.0 nm or smaller. The maximum central pore diameter is preferably 200.0 nm. The central pore diameter can be measured by a method known in the technical field, such as for example, the Barrett Joyner Hallender (BJH) method. The central pore diameter is the pore diameter at a maximum peak of a curve (pore diameter distribution curve) in which the value (dV/dD) obtained by differentiating the pore volume (V) with the pore diameter (D) is plotted against the pore diameter (D).

The porous silica has a porous structure in which many fine pores are formed, and thus, when compounded with the friction material, the liquid matter generated by thermal decomposition of the organic matter in the friction material at the time of brake braking at high-speed high-load, and the like, which causes lowering in fading performance, can be absorbed into the pores. In particular, the thermally decomposed liquid matter of the organic matter can be efficiently absorbed by compounding porous silica including pores having a central pore diameter within the above range. Furthermore, the inflow to the pores of the liquid matter with relatively large molecular weight and high viscosity of resins such as binders at the time of high-temperature/high-pressure molding of the friction material can be suppressed, the friction materials in which the pores are well held can be produced, and the clogging of the pores due to wear powder generated during brake braking is less likely to occur. Thus, the thermally decomposed liquid matter of the organic matter can be effectively and continuously absorbed, and the effect of suppressing the decrease of the friction coefficient at the time of excellent high-speed high-load braking can be exhibited. On the other hand, if the central pore diameter of the pores of the porous silica is smaller than the above range, the absorption of the thermally decomposed liquid matter of the organic matter is delayed. Furthermore, in a case of the thermally decomposed liquid matter of the organic matter in which the molecular size of the high molecular weight organic matter and the like is large, it is not preferable as they cannot be absorbed into the pores, and the effect of suppressing the decrease of the friction coefficient at the time of high-speed high-load braking cannot be sufficiently exhibited. In addition, if the central pore diameter of the pores of the porous silica exceeds the above range, the inflow of the resin such as binders into the pores at the time of high-temperature/high-pressure molding of the friction material, the clogging of pores by wear powder generated at the time of brake braking, and the like may occur. Due to these reasons, it is not preferable as the volume of the pores is reduced and the thermally decomposed liquid matter of the organic matter cannot be absorbed effectively and continuously, and the effect of suppressing the decrease of the friction coefficient at the time of high-speed high-load braking cannot be sufficiently exhibited.

The total volume of the pores formed in the porous silica is preferably greater than or equal to, and particularly preferably greater than or equal to twice the total volume when the organic matter contained in the raw friction materials becomes a liquid matter at 400° C. The organic matter is an organic filler such as cashew dust, a binder such as phenolic resin, and a fiber substrate such as aramid fiber, and in particular, is mostly the liquid matter of the organic filler (cash-dust in the present embodiment). Here, the volume of the thermally decomposed liquid matter of the organic matter can mean, for example, the volume of the components extracted with acetone after heating the organic matter at 400° C. for 1 hour. The heating temperature was set to 400° C., which is a temperature range where a fade phenomenon is recognized. Thus, if the total volume of the pores of the porous silica is greater than or equal to the total volume when the organic matter becomes a liquid matter at 400° C., the total amount of the thermally decomposed liquid matter of the organic matter which is the cause of the lowering in the fading performance can be absorbed theoretically, and the effect of suppressing the decrease of the friction coefficient at the time of excellent high-speed high-load braking can be exhibited. On the other hand, if the total volume when the organic matter becomes a liquid matter at 400° C. exceeds the total volume of the pores of the porous silica, the total amount of the thermally decomposed liquid matter of the organic matter cannot be absorbed, and the thermally decomposed liquid matter of the organic matter remaining on the friction surface may lead to lowering in fading performance, and thus it is not preferable.

The volume of the pores formed in the porous silica is preferably 0.3 cm³/g or greater and 4.0 cm³/g or smaller, particularly preferably 0.6 cm³/g or greater and 1.0 cm³/g or smaller. Thus, the amount of absorption per unit weight is high, the thermally decomposed liquid matter of the organic matter that causes lowering in fading performance can be efficiently absorbed, and the effect of suppressing the decrease of the friction coefficient at the time of excellent high-speed high-load braking can be exhibited. On the other hand, if the volume of the pores is smaller than the above range, it becomes necessary to compound a large amount of porous silica to the friction material in order to absorb the liquid matter, and as a result, the moldability and strength of the friction material decrease and the wearability deteriorate, and thus it is not preferable. In particular, since silica has a relatively high Mohs hardness, it is not preferable as the aggressiveness of the friction material becomes too high if an excessive amount is compounded. When the above range is exceeded, the weight of the porous silica becomes too light, and thus it is not easy to handle and is not suitable as an industrial product for brake pads and the like as it scatters when the raw friction materials are mixed.

The specific surface area of the porous silica is preferably 500 m²/g or greater and 1500 m²/g or smaller, particularly preferably 800 m²/g or greater and 1500 m²/g or smaller, and more preferably 800 m²/g or greater and 1000 m²/g or smaller. If the specific surface area of the porous silica is within the above range, the number of pores per unit weight is large, the thermally decomposed liquid matter of the organic matter that causes lowering in fading performance can be efficiently absorbed, and the effect of suppressing the decrease of the friction coefficient at the time of excellent high-speed high-load braking can be exhibited. On the other hand, if the specific surface area is smaller than the above range, it becomes necessary to compound a large amount of porous silica to the friction material in order to absorb the thermally decomposed liquid matter, of the organic matter and as a result, the moldability and strength of the friction material reduce and the wearability deteriorate, and thus it is not preferable. When the above range is exceeded, the weight of the porous silica becomes too light, and thus it is not easy to handle and is not suitable as an industrial product for brake pads and the like as it scatters when the raw friction materials are mixed.

The shape of the porous silica is not particularly limited as long the characteristics described above can be effectively exhibited and it is mixed with other raw friction materials uniformly, and that of a known form used in the technical field can be used. For example, it can be in the form of powder, particle, fiber, and the like. It is preferably in the form of particles, and particularly preferably the average particle size is 1.0 to 50.0 μm. It is preferable because it exhibits good dispersibility in the raw friction material and also exhibits excellent wear resistance.

The porous silica is preferably mesoporous silica. Mesoporous silica is a silica including fine pores having a uniform and regular meso diameter (2.0 nm or greater and 50.0 nm or smaller), and has physical properties such as not including large pores and having a large pore volume. Such physical properties are suitable for efficient absorption of the thermally decomposed liquid matter of the organic matter. In addition, clogging of the pores due to wear powder generated during brake braking is unlikely to occur, and reduction of the pore volume due to the inflow of resin such as a binder into the pores at the time of high-temperature/high-pressure molding of the friction material do not occur. Therefore, the thermally decomposed liquid matter of the organic matter can be continuously and effectively absorbed, and the effect of suppressing the decrease of the friction coefficient at the time of excellent high-speed high-load braking can be exhibited. The mesoporous silica having various structures such as a two-dimensional or three-dimensional cylindrical structure or a three-dimensional cage structure can be used. For example, those having a uniform structure in which the pores are arranged in a two-dimensional hexagonal shape (hexagonal shape) can also be preferably used, but the uniformity of the pore structure is not particularly required.

As the porous silica, commercially available products can be suitably used, and those manufactured by methods known in the technical field may be used.

As an inorganic filler, various inorganic matters can be contained as necessary other than the porous silica.

For example, an inorganic matter having a Mohs hardness of 6.5 or greater can be contained as an abrasive material. The abrasive material is mainly contained in the friction material to give grinding properties.

As the abrasive material, for example, zirconium silicate, zirconium oxide (zirconia), aluminum oxide (alumina), chromium oxide (chromium oxide (II), etc.) can be used. However, without being limited thereto, an abrasive material known in the technical field can be preferably used. The abrasive material may be used alone or in combination of two or more types. The contained amount of the abrasive material is also not particularly limited, and may be a contained amount generally used in the technical field.

Furthermore, titanate salt can be contained. Examples of titanate salt includes titanic acid alkali metal salt, titanic acid alkali metal/group II salt, and the like, and specific examples thereof include potassium titanate, sodium titanate, lithium titanate, lithium potassium titanate, magnesium potassium titanate and the like. The titanate salt is preferably contained in an amount of 10.0 to 30.0 wt % with respect to the total amount of raw friction materials. The wear resistance can be imparted by containing the titanate salt, and deterioration of the wear resistance involved in the reduction of the copper component can be compensated in a case where it is configured as a friction material that substantially does not contain a copper component having a high environmental load (copper-free).

Furthermore, calcium hydroxide (slaked lime) and the like can be contained as a pH adjusting material.

Furthermore, pure metals such as copper, iron (steel), aluminum, zinc and tin, and metal as well as metals such as metal powder and metal fiber of respective alloy metals can be contained as needed, and the strength of the friction material can be enhanced. However, metal such as metal powder and metal fiber is not an essential component of the friction material and does not necessarily need to be contained from the viewpoint of cost reduction and the like. Therefore, it can be configured as a friction material that substantially does not contain a copper component having a high environmental load (copper-free), in which case the friction material does not contain the copper component or even if it does contain the copper component, it is 0.5 wt % or less with respect to the total amount of raw friction materials.

These inorganic fillers may be used alone or in combination of two or more types. The contained amount of the inorganic filler is not particularly limited, and may be a contained amount generally used in the technical field.

Furthermore, a lubricant can be contained in the friction material friction material for dry brakes in accordance with the present embodiment, and specific examples thereof include coke, black lead (graphite), carbon black, metal sulfide and the like. Examples of metal sulfides include tin sulfide, antimony trisulfide, molybdenum disulfide, tungsten sulfide and the like. The lubricant may be used alone or in combination of two or more types. The contained amount of the lubricant is not particularly limited, and may be a contained amount generally used in the technical field.

The friction material for dry brakes in accordance with the present embodiment can be manufactured through a method known in the technical field, and can be manufactured by a mixing process of compounding and mixing the raw friction materials and a molding process of molding the mixed raw friction materials into a desired shape.

Here, in the mixing process, the raw friction materials are preferably mixed in powder form, so that the raw friction materials can be uniformly mixed easily. The mixing method is not particularly limited as long as the raw friction materials can be uniformly mixed, and the mixing can be carried out through methods known in the technical field. Preferably, mixing can be performed using a mixer such as a Henschel mixer or a Loedige mixer, and for example, mixing is performed for about 10 minutes at normal temperature. At this time, the raw friction materials may be mixed while being cooled through a known cooling method so that the temperature of the mixture does not rise.

The molding process can be performed by pressing and solidifying the raw friction materials with a press or the like, and can be performed based on methods known in the technical field. When performing molding with a press, the molding may be performed through either a hot press method in which the raw friction materials are molded by being heated, pressed and solidified, or a normal temperature press method in which the raw friction material is molded by being pressed and solidified at normal temperature without being heated. In a case where the molding is performed through the hot press method, for example, the molding temperature is 140° C. to 200° C. (preferably 160° C.), the molding pressure is 10 MPa to 30 MPa (preferably 20 MPa), and the molding time is 3 minutes to 15 minutes (preferably 10 minutes). In a case where the molding is performed through the normal temperature press method, for example, molding can be performed by setting the molding pressure to 50 MPa to 200 MPa (preferably 100 MPa) and the molding time to 5 seconds to 60 seconds (preferably 15 seconds). Subsequently, clamp process (e.g., 180° C., 1 MPa, 10 minutes) is performed. Thereafter, heat treatment (preferably 230° C., 3 hours) can be performed at 150° C. to 250° C. for 5 minutes to 180 minutes.

Furthermore, a polishing process may be provided to polish the surface of the friction material to form a friction surface, if necessary.

The friction material for dry brakes in accordance with the present embodiment can be applied to a disc brake pad of a vehicle or the like, but is not limited thereto, and can be applied to any object to which a friction material known in the technical field can be applied such as a brake shoe. For example, the friction material for dry brakes in accordance with the present embodiment can be integrated with a plate-like member such as a metal plate serving as a back plate and used as a brake pad.

According to the friction material for dry brakes of the present embodiment, a decrease in the friction coefficient at the time of high-speed high-load braking can be suppressed and excellent fading performance can be demonstrated by containing porous silica including a large number of pores having a specific central pore diameter. The occurrence of the fade phenomenon can be effectively suppressed by the porous silica absorbing the liquid matter of the organic matter thermally decomposed under a high temperature environment that causes the fading phenomenon. Since the occurrence of a sufficient fade phenomenon can be suppressed without limiting the compounding amount of organic matters such as organic fillers and binders, it has sufficient strength and can maintain excellent flexibility and wear resistance.

### EXAMPLES

Examples of the friction material for dry brakes according to the present embodiment will be described below, but the present invention is not to be limited to these examples.

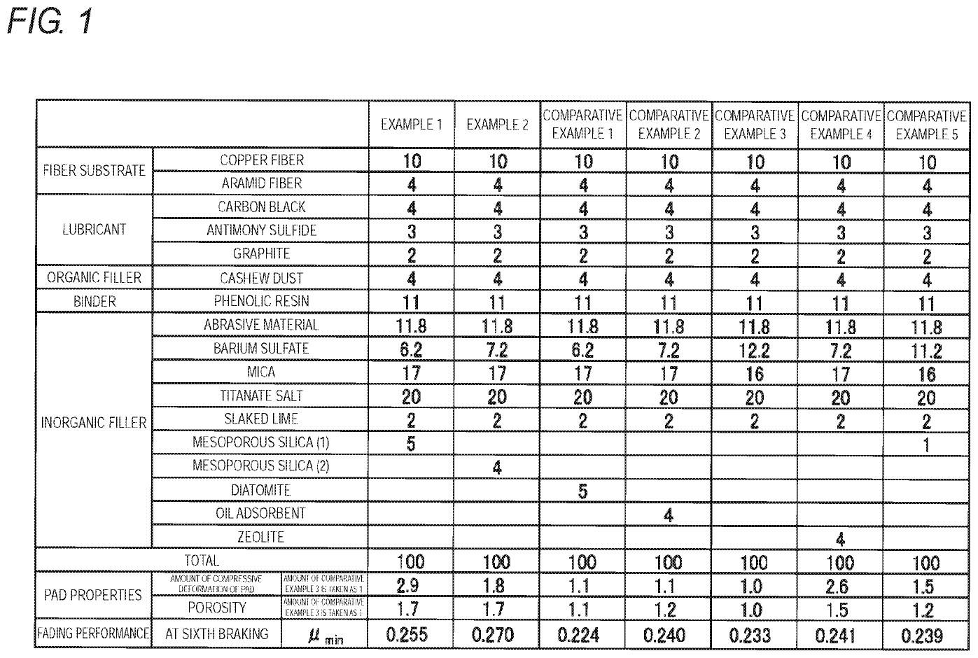

In Examples 1 to 2 and Comparative Examples 1 to 5, the friction material prepared by compounding the raw friction materials according to the compounding amount shown in FIG. 1 was used in a brake pad, and pad properties and fading performance were evaluated. The unit of compounding amount in the composition of each raw friction materials in the FIGURE is wt % with respect to the total amount of raw friction materials.

In Examples 1 and 2, mesoporous silica (Example: mesoporous silica (1), Example 2: mesoporous silica (2)) having different physical properties was blended as porous silica. In Comparative Example 1, diatomite was blended instead of porous silica. In Comparative Example 2, an oil adsorbent was blended instead of porous silica. As the oil adsorbent, “OSLITE” manufactured by YSP Co., Ltd. was used. This oil adsorbent absorbs 4-5 times more oil than diatomite. In Comparative Example 3, no porous silica was blended, and no other alternative material was blended. In Comparative Example 4, zeolite was blended instead of porous silica. Zeolite is a porous structural body including a micropore having a central pore diameter of about 0.4 nm. In Comparative Example 5, the same mesoporous silica (1) blended in Example 1 was blended, but the blending amount was ⅕.

Table 1 below summarizes the physical properties of each compound of mesoporous silica, diatomite, and oil adsorbent used in Examples and Comparative Examples. In the table, the central pore diameter refers to a pore diameter at a maximum peak of a curve (pore diameter distribution curve) in which the value (dV/dD) obtained by differentiating the pore volume (V) with the pore diameter (D) is plotted against the pore diameter (D), and was measured by the Barrett Joyner Hallender (BJH) method or the like.

TABLE 1

| | | PERCENTAGE OF | | | |
|---|---|---|---|---|---|
| | CENTRAL | PORES WITH A | SPECIFIC | | |
| | PORE | DIAMETER OF 200 | SURFACE | PORE | PARTICLE |
| | DIAMETER | nm OR MORE | AREA | VOLUME | SIZE |
| COMPOUND NAME | (nm) | (%) | (m2/g) | (cm3/g) | (μm) |
| MESOPOROUS SILICA (1) | 2.7 | 0 | 856 | 0.706 | 5 |
| MESOPOROUS SILICA (2) | 4.0 | 0 | 831 | 0.872 | 19 |
| DIATOMITE | 400 | 73 | 100 | 0.2 | 1000 |
| OIL ADSORBENT | — | — | — | — | 1400 |

Furthermore, for the amount of thermally decomposed liquid matter of the organic matter in the friction materials of the Example and the Comparative Example, the component amount is that in which the organic filler (cashew dust) is heated at 400° C. for 1 hour and extracted with acetone, and it was 0.3 cm³ per gram of cashew dust.

(Pad Properties)

The pad properties were evaluated by porosity and the amount of compressive deformation of the pad. All the measurement results are shown as relative values with the measurement value in Comparative Example 3 as 1.

The measurement of porosity was conducted by the oil impregnation method according to JIS D4418.

The measurement of the amount of compressive deformation of the pad was conducted according to JIS D4413.

(Fading Performance)

Using the full-size dynamometer testing machine, only the first fade test was conducted among the dynamometer tests following JASO C406 (passenger vehicle). In addition, sliding contact was performed 50 times before the test. From the obtained results, the numerical values for the sixth braking with the lowest friction coefficient were compared.

The results are shown in FIG. 1. In Examples 1 and 2 in which mesoporous silica was compounded, it was recognized that the decrease in the friction coefficient at the time of fading was suppressed and excellent fading performance was achieved. It is considered that the thermally decomposed liquid matter of the organic matter that causes a decrease in the fading performance was absorbed into the pores of the mesoporous silica.

On the other hand, in Comparative Example 1 in which diatomite including large pores was compounded, a decrease in the friction coefficient was confirmed. Furthermore, in Comparative Example 2 in which the oil adsorbent was compounded and in Comparative Example 4 in which the zeolite was compounded as well, the decrease in the friction coefficient could not be effectively suppressed, and a sufficient fading performance improvement effect could not be obtained. Zeolite is a porous structural body, but since it includes micropores having a central pore diameter of about 0.4 nm, the absorbability of the thermally decomposed liquid matter of the organic matter is low, and it is considered that sufficient effects could not be exhibited. Furthermore, in Example 5 in which only 1 wt % of mesoporous silica (1) having a pore volume of 0.705 cm³/g was compounded, the decrease in the friction coefficient could not be effectively suppressed, and a sufficient fading performance improving effect could not be obtained. The friction material of Comparative Example 5 has a low porosity, which is considered to be because the pore volume enough to absorb the entire amount of the thermally decomposed liquid matter of the organic matter could not be ensured. From these results, it has been found that it is important to appropriately control the central pore diameter and the pore volume of the porous silica in order to effectively exhibit excellent fading performance.

Furthermore, it was confirmed that Examples 1 and 2 in which mesoporous silica was compounded have good characteristics in terms of compression deformation property.

### INDUSTRIAL APPLICABILITY

The friction material of the present invention can be applied to a field where a friction material known in the technical field is required, such as a disk brake pad or a brake shoe for a vehicle.

1. A friction material for dry brakes comprising, as raw friction materials:
a fiber substrate;
a binder;
an organic filler; and
an inorganic filler, wherein
porous silica including a plurality of pores with a central pore diameter of 1.0 nm or greater and 50.0 nm or smaller that absorbs liquid matter generated by thermal decomposition of an organic matter in the friction material at the time of brake braking is contained as the inorganic filler.

2. The friction material for dry brakes according to claim 1, wherein a total volume of the pores of the porous silica is greater than or equal to a total volume when an organic matter contained in the raw friction materials becomes a liquid matter at 400° C.

3. The friction material for dry brakes according to claim 1, wherein a specific surface area of the porous silica is 500 m²/g or greater and 1500 m²/g or smaller.

4. The friction material for dry brakes according to claim 1, wherein a volume of the pores of the porous silica is 0.3 cm³/g or greater and 4.0 cm³/g or smaller.

5. The friction material for dry brakes according to claim 1, wherein the porous silica is mesoporous silica.

6. The friction material for dry brakes according to claim 2, wherein a specific surface area of the porous silica is 500 m²/g or greater and 1500 m²/g or smaller.

7. The friction material for dry brakes according to claim 2, wherein a volume of the pores of the porous silica is 0.3 cm³/g or greater and 4.0 cm³/g or smaller.

8. The friction material for dry brakes according to claim 2, wherein the porous silica is mesoporous silica.

9. The friction material for dry brakes according to claim 6, wherein a volume of the pores of the porous silica is 0.3 cm³/g or greater and 4.0 cm³/g or smaller.

10. The friction material for dry brakes according to claim 6, wherein the porous silica is mesoporous silica.

11. The friction material for dry brakes according to claim 7, wherein the porous silica is mesoporous silica.

12. The friction material for dry brakes according to claim 3, wherein a volume of the pores of the porous silica is 0.3 cm³/g or greater and 4.0 cm³/g or smaller.

13. The friction material for dry brakes according to claim 3, wherein the porous silica is mesoporous silica.

14. The friction material for dry brakes according to claim 12, wherein the porous silica is mesoporous silica.

15. The friction material for dry brakes according to claim 4, wherein the porous silica is mesoporous silica.

16. The friction material for dry brakes according to claim 9, wherein the porous silica is mesoporous silica.
